(19) United States
(12) Patent Application Publication
(10) Pub. No.: US 2006/0255939 A1
(43) Pub. Date: Nov. 16, 2006

(54) Methods and apparatus for merchandising articles of clothing

(76) Inventor: Donald Spector, New York, NY (US)

Correspondence Address: Glen M. Diehl;NORTON & DIEHL LLC, Suite 110, 77 Brant Avenue, Clark, NJ, 07066, US

(21) Appl. No.: 11/128,886

(22) Filed: May 13, 2005

(51) Int. Cl. G08B 13/14

(52) U.S. Cl. 340/568.1

(57) ABSTRACT

A method and apparatus for retailing articles of clothing are disclosed. An article of clothing is provided with an electronic memory device. The electronic memory device can be an optical disk or a jump drive or the like. It contains information about how to accessorize or match the article of clothing with other articles of clothing. The information includes both general information and specific recommendations as to which additional articles of clothing to buy. Also, a kiosk-type structure can be provided in a retail outlet. The structure includes an input device, a display and memory. An information tag, such as a bar code, is provided on each article of clothing. When the identifier tag is input to the input device, the information concerning the information about how to accessorize the article of clothing with other articles of clothing is displayed on the display. Other information that has been described as being provided on the electronic device can also be stored in the memory in the structure and can be displayed on the display. Additionally, goods other than clothing that can be accessorized can be sold this way.

### BACKGROUND OF THE INVENTION

This invention relates to the merchandising of articles of clothing.

Many people do not know how to match various articles of clothing. For example, certain patterns and colors match, and to look good, a person needs to know how to match these various items of clothing. Accessorizing is important in looking good when dressing. For example, when a customer buys a striped charcoal suit, certain shirts, ties and even shoes look good with the suit. It would be very helpful to purchasers of articles of clothing if they could have a system and method that helps them accessorize and to buy matching associated articles of clothing. Such a system would also help retailers by assisting their customers and by helping their sales people to become more knowledgeable about the articles of clothing they are selling.

### SUMMARY OF THE INVENTION

The present invention provides improved methods and retail sales kits to merchandise articles of clothing. It assists customers who may be unaware how to best buy additional articles of clothing that will match the article of clothing being purchased—that is how to accessorize. It will also assist manufacturers of clothing because they can assist their customers by providing information about the articles of clothing being sold and about the manufacturer. It will also assist retailers who can provide additional information about their goods, locations and the like, and can also increase the information being provided to their customers.

In accordance with one aspect of the present invention, a retail sales kit is provided. The retail sales kit includes an article of clothing and an electronic memory device. The electronic memory device contains information about how to accessorize the article of clothing with other articles of clothing. The electronic memory device is included with the article of clothing and is preferably attached to the article of clothing.

In one embodiment of the present invention, the electronic memory device is an optical disk. For example, a CD or a DVD can be used. If a CD is used, any of the available sized CDs can be used. Other forms of electronic memory devices can also be used. By way of example only, the electronic memory device can be a jump drive.

In another aspect of the present invention, a cover for the electronic memory device is included with the retail sales kit. The electronic memory device is placed in the cover, and the cover for the electronic memory device is attached to the article of clothing.

The information about how to accessorize the article of clothing with other articles of clothing preferably includes text information and color pictures. Additionally, information concerning a manufacturing company that makes the article of clothing can be stored on the electronic memory device. Further, information concerning a retail company that is selling the article of clothing can be stored on the electronic memory device. Also, information concerning how to dress in general can be stored on the electronic memory device.

In accordance with a further aspect of the present invention, an identifier tag is associated with the article of clothing. A structure having a display and an input device is provided in the retail outlet. The identifier tag can be a bar code or other information bearing device and the input device on the structure can be a bar code scanner or other input device. The information concerning how to accessorize the article of clothing with other articles of clothing is preferably stored in a memory in the structure. When the identifier tag is input to the input device, the information concerning the information about how to accessorize the article of clothing with other articles of clothing is displayed on the display. Other information that has been described as being provided on the electronic memory device can also be stored in the memory in the structure and can be displayed on the display. The structure also can include a processing circuit or processor and a connection to the Internet.

In accordance with another aspect of the present invention, a method of selling an article of clothing is provided. The method includes the steps of storing information concerning how to accessorize the article of clothing with other articles of clothing on an electronic memory device, covering the electronic memory device and the attaching the electronic memory device to the article of clothing.

The method further includes the step of placing the article of clothing and the electronic memory device on a sales rack and offering the combination of the article of clothing and the electronic memory device for sale.

In performing this method, all of the previously mentioned information can be stored on the electronic memory device.

### DESCRIPTION OF THE DRAWINGS

FIG. 1 illustrates an article of clothing with an attached electronic memory device on a retail rack.

FIG. 2 illustrates optical disks of several sizes.

FIG. 3 illustrates a jump drive.

FIGS. 4 and 5 illustrate various organizations of the information on the electronic memory device and on the memory of the structure shown in FIGS. 6 and 7.

FIG. 6 illustrates a kiosk-type structure that is located in a retail outlet that is used in association with the articles of clothing or with identifying tags associated with the article of clothing.

FIG. 7 illustrates a block diagram of the electronics of the structure of FIG. 7.

### DESCRIPTION OF A PREFERRED EMBODIMENT

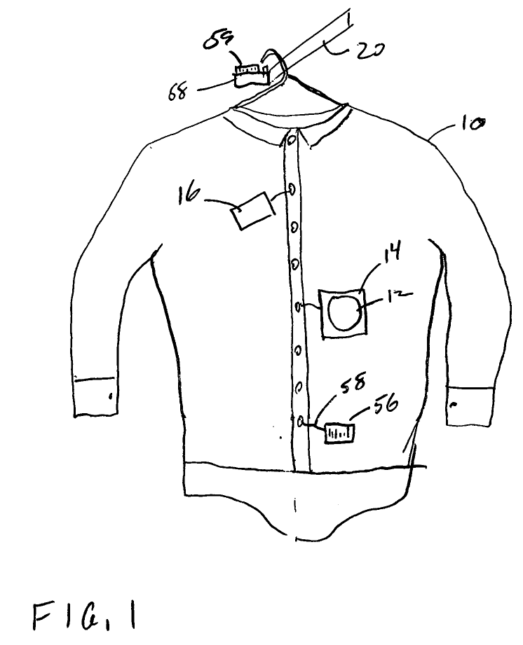

FIG. 1 illustrates an article of clothing 10 that will be offered for sale. The article of clothing is a shirt, although it can be any type of article of clothing, such as pants, a suit, a tie, a jacket, socks, or shoes. This list is provided without limitation. The article of clothing can also be a man's garment, a women's garment or a child's garment.

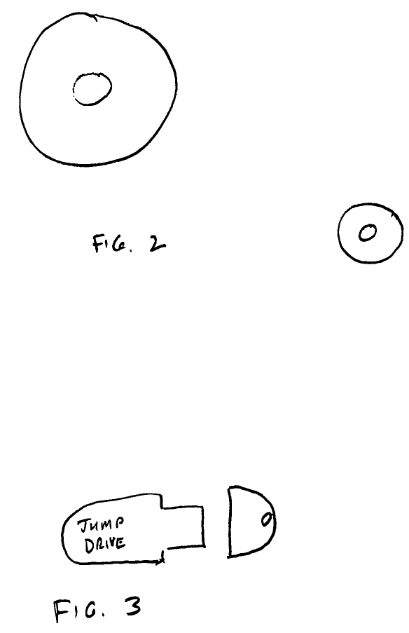

The shirt 10 has an electronic memory device 12 associated with it. The electronic memory device 12 is preferably an optical disk. The optical disk 12 is preferred because it can provide large amounts of information at a reasonable price. The optical disk 12 can be a CD. It can also be a DVD disk. The optical disk 12 can be any of the available sizes of disks. FIG. 2 illustrates two optical disks of different sizes that can be used.

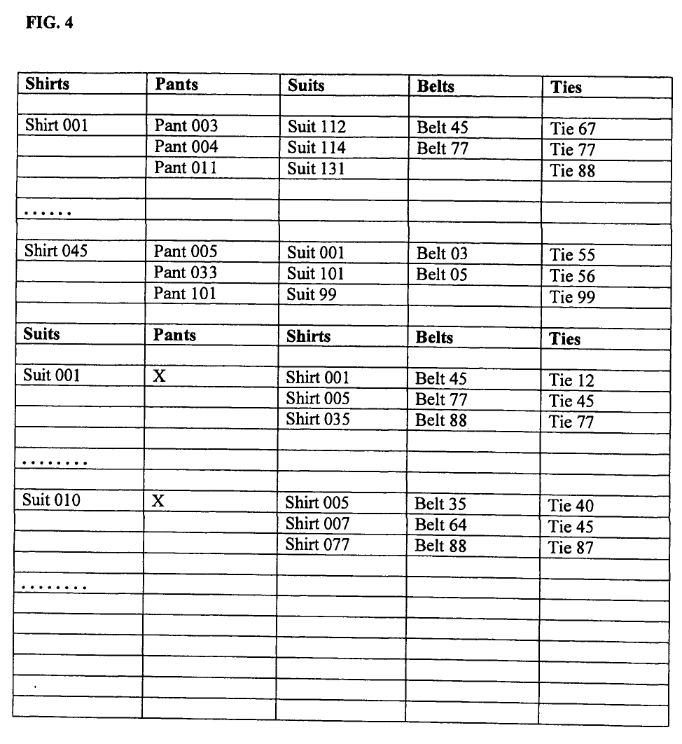

The electronic memory device 12 can also be a jump drive. FIG. 3 illustrates a jump drive. Such devices are available from Lexar and from SanDisk. Other electronic memory devices can also be used. For example, a memory stick, generally available from Sony could also be used. Older technology, such as a floppy disk could also be used, but is not preferred.

The electronic memory device 12 illustrated in FIG. 1 is covered with a cover 14. The cover is preferably a plastic sleeve, but any other of the well known enclosures can also be used.

The shirt also includes the typical tags 16 found on merchandise for sale in retail outlets. These tags include information about the article of clothing being offered for sale. A price sticker is also frequently found on these tags. The shirt 10 is shown hung on a retail rack 20.

The electronic memory device 12 stores information that will help a customer who is considering the purchase of the shirt 10 understand what other articles of clothing would be a match with the shirt. In short, the information on the electronic memory device 12 helps a customer accessorize the shirt 10 or any other article of clothing that the customer is considering purchasing.

The information on the electronic memory device 12 includes information about how to accessorize an article of clothing. Thus, the information tells a customer what other clothes to buy with a particular article of clothing. The information can provide specific recommendations on other articles of clothing to buy. That is, if a customer is considering a certain suit, the information can provide a recommendation on certain shirts and ties that match the suit to consider buying.

The information on the device 12 can also provide general recommendations on other articles of clothing to buy. So if a customer is considering a certain suit, say a blue striped suit, the information can provide a recommended list of types of shirts and ties to buy. For example, the information might recommend a white or light blue solid shirt and a dark blue tie.

The information on the device 12 can include text information and pictures. The text information describes the article of clothing being purchased as well as the articles of clothing that would match the item being purchased. The picture information could show how certain items would look together.

The information provided can also include information concerning a manufacturing company that makes the article of clothing is stored on the electronic memory device. It can also include information about a new technology or innovation that is used to manufacture the article of clothing. It can also include information concerning a retail company that is selling the article of clothing.

The information stored on the electronic memory device 12 can also include information concerning how to dress in general. For example, a well known book on how to dress could be provided in electronic format.

The information stored on the electronic memory device 12 can also include recommended outfits. So, for example, a suit, shirt, belt etc. can be recommended.

FIG. 4 illustrates one way to format information on the electronic memory device 12 and one type of information. In this organization, specific recommendations for items of clothing are provided.

In general, in FIG. 4, each shirt on sale in a retail store is included and for each shirt, there is one or more recommendations for pants, suits, belts and ties. Other items could also be provided. As an example, if a customer bought shirt 001, the customer could insert the electronic memory device 12 into a computer. The electronic memory device 12 would store a program that causes the information associated with the shirt 001 to be selectively displayed. The program would also allow the other information stored on the electronic memory device 12 to be selectively displayed as well, so the customer can view information about the manufacturer and the retailer.

Referring to FIG. 4, it can be seen that Pant 003, Pant 004 and Pant 011 are recommended matches for Shirt 001. Similarly, Suit 112, Suit 114 and Suit 131 are also recommended matches for Shirt 001. Recommendations for belts and ties are also made. These recommendations are made for all shirts in the retail store, Shirt 001-Shirt 045. Then specific recommendations for suits are made. It is preferred that specific recommendations be made for each item of clothing for sales or at least for most items for sale. Again, pictures showing the recommended item and/or the combination of the items can also be stored and displayed to the customer.

All of the information illustrated in FIG. 4 can be stored on the electronic memory device 12. Alternatively, only the information related to the article of clothing 10 needs to be stored on the electronic memory device 12.

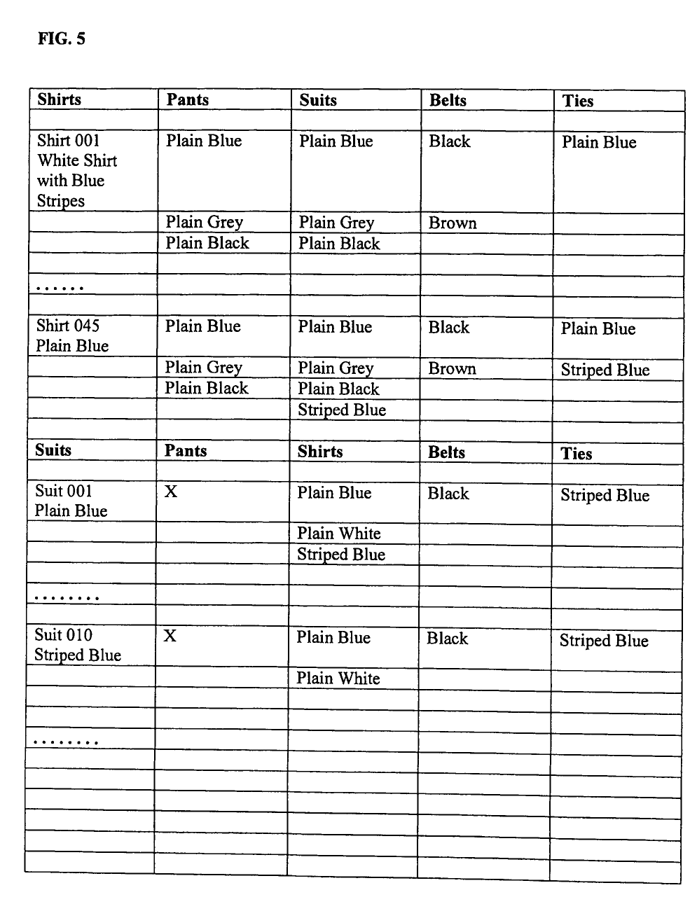

FIG. 5 illustrates information stored on the electronic memory device 12 where general recommendations are made to a customer. Once again, each or most items offered for sale by a retail outlet are included. This time, the recommendations are general in nature. So, for Shirt 101, plain blue pants, plain grey pants and plain black pants are recommended. As far as suits are concerned, plain blue suits, plain grey suits and plain black suits are recommended. Similarly, general recommendations for belts and ties are made. Related pictures can be provided as well.

Again, while FIG. 5 illustrates recommendations for a plurality of articles of clothing, the electronic memory device 12 only needs to store information relating to the article of clothing that is associated with the electronic memory device 12.

Of course, a combination of information can be provided on the electronic memory device 12. So, for example, specific recommendations and general recommendations for each item of clothing could be provided. In this case, the information from FIG. 4 and from FIG. 5 is combined.

As previously mentioned, pictures can be associated with each recommended article of clothing to show how the combination of clothes would look.

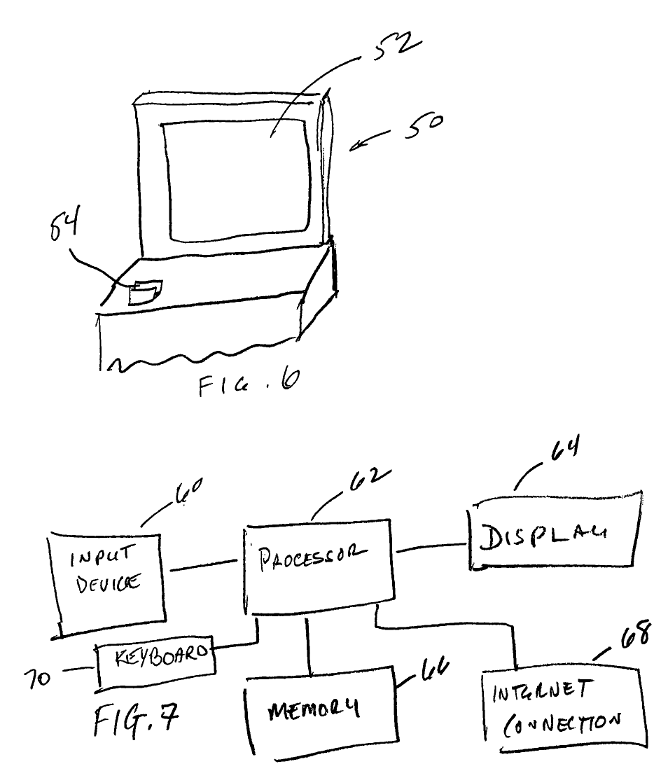

FIGS. 6 and 7 illustrate a kiosk-type structure 50 that can be placed in a retail outlet. The structure 50 is preferably on a stand so that a customer can walk up to the structure and interface with the structure 50. A customer using the structure 50 sees a display 52 and an input device 54. The customer can use the structure 50 to determine what other articles of clothing in the store would match or accessorize an article of clothing of interest to the customer while in the retail store. The structure 50 thereby helps the customer to make additional purchases to accessorize the article of clothing of interest while in a store instead of having to wait until they got home.

Referring back to FIG. 1, a tag 56 is preferably attached to the article of clothing 10. The tag 56 is attached to the article of clothing 10, preferably via a plastic string 58 in a well known manner. The tag 56 includes a bar code, or other identifying information, to indicate the identity of the article of clothing.

To use the structure 50, the customer scans the tag 56 through the input device 54. The input device 54 is a bar code scanner or other scanning device that can read the information on the tag 56. The input device 54 identifies the article of clothing of interest. Based on the identity of the article of clothing, the structure 50 specifies other articles of clothing that will match or go with the article of clothing of interest.

Referring back to FIG. 1 again, the retail display of the article of clothing 10 can also include a holder 58. The holder 58 contains one or more identifying cards 59. The cards 60 provide the same function as the tag 56. Thus, the cards 59 can have a bar code that identifies the article of clothing 10. A customer can take one of the cards 59 to the kiosk-type structure 50 to find other articles of clothing that match the article of clothing 10. Thus, the card 59 performs the same function as the tag 56.

FIG. 5 illustrates a block diagram of the electronics of the structure 50, which could simply be a personal computer programmed to perform in a manner described herein. The structure includes an input device 60, a processor 62, a display 64, a memory 66 and an internet connection device 68. The input device 60, such as a bar code scanner, is connected to the processor 62. The processor 62 can be a microprocessor or a simple processing circuit or even a simple processing device. The processor 62 is connected to the display 64, to the memory 66 and to the internet connection device 68.

When the tag 56 or the card 59 is swiped or otherwise input to the input device 60, the input device generates a signal that identifies the article of clothing of interest. This identifying signal is input to the processor 62. The processor 62 uses the identifying signal to access the memory 64. The memory 64 stores suggestions of specific articles of clothing that would match the article of clothing of interest, such as the shirt 10. Thus, for example, the memory 64 could store an identifier of the shirt 10 and suggested other items to buy that match the shirt 10, such as suits, pants, belts, ties, etc. Of course, the memory 64 would store suggested other items to buy for all of the items for sale in the store, including pants, suits, etc. Thus, there would be a listing for every item or at least most items in the retail store. The information in the memory 64 could be organized in a manner similar to that illustrated in FIG. 4. In this case, however, all of the information in FIG. 4 is stored in the memory 64. Preferably, information about all of the items for sale in a retail store is provided.

Alternatively, the memory 64 could store descriptions of other clothing items that would match the article of clothing of interest. Thus, for example, if the shirt 10 is blue and striped, then a description of matching items that specifies colors and designs could be provided in the memory 64 in association with the identified article of clothing of interest. An example of the organization of the memory 64 in this embodiment is illustrated in FIG. 5. Again, information about all of the items for sale in a retail store is provided.

After the customer inputs the tag 56 or the card 59, the processor 62 determines the article of clothing from the tag 56 or card 59 and accesses the memory 64 with that information. The information retrieved from the memory 64 is formatted for display by the processor 62. The processor 62 causes that information to be displayed to a customer on the display 62.

The internet connection 68 is provided to allow a manufacturer of clothing to download information relating to the manufacturer's clothing that is on sale in the store. The processor 62 reads the information relating to each item offered by the manufacturer and stores that information in the memory 64. Additionally, a keyboard 70 is provided to allow a retail store to enter its own information concerning other items of clothing that are on sale in the store. The retail store owner can also enter information about the retail store and its merchandise, including any specials that the retail store may be offering.

The present invention has been described with respect to clothing and accessorizing. The method and apparatus disclosed herein can also be used with the merchandising of other retail products that might require additional add on products (such as computers, mobile sound equipment, cars etc.) as well as general instructions on how to use the product. For example, the present invention could also be used with pharmaceuticals to provide information and visual pictures of contra indications that can be sent to both doctors and patients. This could be part of a normal medication practice in the future.

It is also an aspect of the present invention to provide a kiosk-like structure in a mall where customers could enter information concerning a product to check the availability of the product at various stores in the mall or in a surrounding area or on the Internet and to check the pricing of the product from these locations. Alternatively, a call center could be provided wherein a customer can call—via a land line or cell phone—to enter the product number and to check availability and pricing from a variety of locations. Further, if the consumer enters the price of the product along with the product identification into the kiosk-like structure in the mall or during the call to the call center, either of these devices could provide retail outlets that have the product available for less money.

Although the invention herein has been described with reference to particular embodiments, it is to be understood that these embodiments are merely illustrative of the principles and applications of the present invention. It will be apparent to those skilled in the art that various modifications and variations can be made in the apparatus and methods of the present invention without departing from the spirit and scope of the invention. Thus, it is intended that the present invention include modifications and variations that are within the scope of the appended claims and their equivalents.

1. A retail sales kit, comprising:
an article of clothing; and
an electronic memory device, the electronic memory containing information about how to accessorize the article of clothing with other articles of clothing, the electronic memory device being included with the article of clothing.

2. The retail sales kit as claimed in claim 1, wherein the electronic memory device is an optical disk.

3. The retail sales kit as claimed in claim 2, wherein the electronic memory device is a CD.

4. The retail sales kit as claimed in claim 2, wherein the electronic memory device is a DVD.

5. The retail sales kit as claimed in claim 2, wherein the electronic memory device is a jump drive.

6. The retail sales kit as claimed in claim 1, further comprising a cover for the electronic memory device.

7. The retail sales kit as claimed in claim 1, wherein the electronic memory device is attached to the article of clothing.

8. The retail sales kit as claimed in claim 6, wherein the cover for electronic memory device is attached to the article of clothing.

9. The retail sales kit as claimed in claim 1, wherein the information about how to accessorize the article of clothing with other articles of clothing includes text information and color pictures.

10. The retail sales kit as claimed in claim 1, wherein information concerning a manufacturing company that makes the article of clothing is stored on the electronic memory device.

11. The retail sales kit as claimed in claim 11, wherein information concerning a retail company that is selling the article of clothing is stored on the electronic memory device.

12. The retail sales kit as claimed in claim 1, wherein information concerning how to dress in general is stored on the electronic memory device.

13. The retail sales kit as claimed in claim 1, further comprising:
an identifier tag associated with the article of clothing;
a structure having a display and an input device;
wherein when the identifier tag is input to the input device, the information concerning the information about how to accessorize the article of clothing with other articles of clothing is displayed on the display.

14. A method of selling an article of clothing, comprising:
storing information concerning how to accessorize the article of clothing with other articles of clothing on an electronic memory device:
covering the electronic memory device; and
attaching the electronic memory device to the article of clothing.

15. The method as claimed in claim 14, further comprising placing the article of clothing and the electronic memory device on a sales rack and offering the combination of the article of clothing and the electronic memory device for sale.

16. The method as claimed in claim 15, further comprising storing information concerning a manufacturing company that makes the article of clothing on the electronic memory device.

17. The method as claimed in claim 15, further comprising storing information concerning a retail company that sells the article of clothing on the electronic memory device.

18. The retail sales kit as claimed in claim 14, further comprising storing information concerning how to dress in general on the electronic memory device.

19. The method as claimed in claim 14, wherein the electronic memory device is a CD.

20. A retail sales kit, comprising:
an article that can be offered for sale; and
an electronic memory device, the electronic memory containing information about how to accessorize the article that can be offered for sale with other articles, the electronic memory device being included with the article that can be offered for sale.
